(19) United States
(12) Patent Application Publication
(10) Pub. No.: US 2019/0347751 A1
(43) Pub. Date: Nov. 14, 2019

(54) SYSTEM AND METHOD FOR AUTOMATED APPROVAL OF BUILDING PROPOSAL

(71) Applicant: SOFTTECH ENGINEERS LIMITED, Pune (IN)

(72) Inventor: Vijay Shantiswarup GUPTA, Pune (IN)

(21) Appl. No.: 16/315,169

(22) PCT Filed: Jan. 30, 2018
(86) PCT No.: PCT/IN2018/050045

§ 371 Date: Jan. 4, 2019

(30) Foreign Application Priority Data
Feb. 6, 2017 (IN) 201721004157

(51) Int. Cl. G06Q 50/26; G06Q 50/16; G06Q 50/08; G06Q 10/10

(52) U.S. Cl. CPC G06Q 50/26; G06Q 10/103; G06Q 50/08; G06Q 50/16

(57) ABSTRACT

Disclosed is a system (100) and a method (300) for automated approval of a building proposal. The system (100) and the method (300) enables submission of a single building proposal through an automated single window platform and receive therefrom a plurality of approvals and digitally signed NOC's and certificates from building and construction authority and various government departments, thereby reducing on the time-cycle required for approval of the building proposal. The system (100) and the method (300) is cost effective and enables citizens to keep track of the building proposal throughout the approval process.

### FIELD OF INVENTION

The present invention relates to a system and method for automated approval of a building proposal.

### BACKGROUND OF THE INVENTION

For any building to get constructed, the builder and his team needs to go through a long and complex process which entails the following steps: making an application or proposal and submitting the requisite documents, getting the building plan and layout approved from local building plan approval authorities, getting pre-commencement No-Objection Certificates (NOCs) from local concerned departments, getting the building plan/drawing scrutinized based on the prevailing complex interlinked building codes/regulations, issuance of Commencement Certificate before the actual construction work commences, issuance of Completion Certificate after the construction is complete, getting post-completion NOCs from local concerned departments and getting Occupancy Certificate before the occupation of a building or part thereof begins.

Conventionally, all the afore-stated process steps have been carried out manually. Furthermore, due to the complexity of this procedure and interpretation of regulations due to the involvement of various stakeholders in their scrutiny and approval, the afore-stated process is fraught with a multitude of challenges such as extensive amount of time for completion, arbitrariness and subjectivity in scrutiny by different stakeholders, inaccurate interpretation of complex rules and bye laws, human errors in the calculation of areas and calculation of scrutiny fees lack of visibility of the approval process to the applicants and citizens, increased chances of human errors due to manual submission and scrutiny and the like.

The inventor of the present invention has envisaged an automated building proposal approval method and system which aims at mitigating the afore-stated drawbacks.

### OBJECTS OF THE INVENTION

It is an object of the present invention to provide a system for enabling automated building proposal approval.

It is another object of the present invention to provide an automated method for enabling automated building proposal approval.

It is another object of the present invention to provide a system and method for scrutiny of building plans without any manual intervention.

It is still another object of the present invention to provide a system and method for building proposal approval which is single window.

It is yet another object of the present invention to provide a system and method for building proposal approval which is cost and time efficient.

It is still another object of the present invention to provide a system and method for building proposal approval which is transparent.

It is still another object of the present invention to provide a system and method for building proposal approval which precludes instances of human error.

It is still another object of the present invention to provide a system and method for building proposal approval which has a small environmental footprint.

It is still another object of the present invention to provide a system and method for building proposal approval which calculates all the areas and fees automatically by reading objects present in the CAD drawing/BIM model.

It is still another object of the present invention to provide a system and method for building proposal approval which will automatically issue digitally signed approval letters and final drawing in PDF format along with email/SMS based alerts.

It is still another object of the present invention to provide a system and method for building proposal approval which automatically verifies drawing by mapping drawing objects with the prevailing building regulations ensuring uniform interpretation of building regulations/codes.

It is still another object of the present invention to provide a system and method for building proposal approval which will scrutinize the drawings in queue (FIFO) automatically on server and will provide scrutiny results online to applicant without any intervention.

It is still another object of the present invention to provide a web interface with which government officials (or users) can modify the building codes/regulations which will be automatically updated during scrutiny of CAD drawing/BIM model.

### SUMMARY OF THE INVENTION

The present invention, in one aspect, provides a system for automated approval of a building proposal. The building proposal includes a building plan, a Building Information Modeling (BIM) model, and documents related thereto along with applicant and owner related information. The system comprises of a central scrutiny server, a plurality of application server, and a plurality of computing device operatively coupled with each other. The central scrutiny server includes a Central Load-balancing and Distribution module configured thereon for uniform distribution/allocation of the building proposal submitted by applicant over a communication network to automatically scrutinize CAD drawing/BIM model and seek approval from building and construction authority for commencement of construction work. The plurality of application server is operatively coupled to the central scrutiny server for receiving therefrom the building proposal uniformly allocated amongst the plurality of application server by the Central Load-balancing and Distribution module. Each application server of the plurality of application server includes a web application configured thereon for automated approval of the building proposal.

The web application comprises of a rules database, a proposal database, a verification module, a mapping module, a report generating module, a billing module, a tracking module and a certificate issuing module operatively coupled with each other. The rules database includes jurisdiction specific information stored therein pertaining to development control rules, byelaws, policies, sanctions and circulars issued by the building and construction authority. The proposal database includes plurality of building proposal stored therein, pertaining to the building proposal received from the applicant seeking approval/permit letter for commencement of construction work/plinth/completion/occupancy, and the building proposal approved and rejected by the building and construction authority. The verification module verifies correctness and authenticity of the building proposal in addition to performing a site inspection analysis and an overlay analysis. The site inspection analysis uses site inspection visit report and on-site images captured and uploaded on the web application via the central scrutiny server by a government officer using a handheld device. The site inspection analysis compares the building proposal with the site inspection visit report and the on-site images to report inconsistency therebetween followed by proposing a strategy for clearance of said inconsistency. The overlay analysis uses plot data and city master plan parameters retrieved automatically from a GIS city map and city map provisions are verified against the BIM model and the building plan/drawing submitted at building and construction authority. The overlay analysis overlays the building plan and the BIM model onto the plot data and the city master plan parameters to report inconsistency therebetween followed by proposing a strategy for clearance of said inconsistency. The mapping module performs compliance analysis by mapping the building proposal against the rules database to report non-compliance therewith, if any, followed by proposing a strategy for clearance of said non-compliance. The report generating module generates an interactive scrutiny report, a comprehensive analysis report and a Management Information System (MIS) report based upon findings of the verification module and the mapping module, and thereafter displays a status update online for the applicant on an interactive dashboard. The billing module computes a fee associated with all the activities including verification, site inspection visit followed by site inspection analysis, overlay analysis, compliance analysis, generation of multiple reports, and issuance of plurality of certificates and plurality of No-objection certificate (NOC). The billing module facilitates online payment of the computed fee by presenting an invoice to the applicant along with a payment module. The tracking module schedules date and time of site inspection visit by the government officer, and communicates the same to the applicant and the government officer. The tracking module further allows to schedule site inspection visit and sends alerts to confirm the site inspection visit on the scheduled date and time, and provides timely status updates to the applicant about progression/advancement of the building proposal seeking approval.

Optionally, the applicant assesses the web application via the central scrutiny server over the communication network for tracking/checking status of the building proposal submitted by the applicant. The certificate issuing module issues digitally signed copies of the certificates obtained from the building and construction authority and the NOC's obtained from government department and identified by the certificate issuing module along with the applicant. The certificate includes anyone of a commencement certificate, a completion certificate and an occupancy certificate. The reports generated by the report generating module and the digitally signed copies of the certificates are stored within the proposal database for future use. The plurality of computing device operably coupled to the central scrutiny server for data transfer therebetween is used by the applicant for uploading and submitting the building proposal on the web application and for receiving therefrom the certificates and the NOC's. Each computing device of the plurality of computing device includes a processor, memory, input device and display device operatively coupled thereto. The computing device additionally includes a CAD/CAM system configured thereon for designing of the building proposal along with an error reporting module operatively coupled thereto for reporting drafting and modeling errors within the designed building proposal.

In another aspect, the present invention provides a method for automated approval of the building proposal designed by the applicant using the CAD/CAM system for uploading onto the web application. The method includes the mapping module performing compliance analysis of the building proposal upon ensuring correctness and authenticity thereof by the verification module.

Thereafter, the method includes scheduling the site inspection visit of the government officer followed by performing the site inspection analysis by the verification module to report inconsistency between the site inspection visit report, on-site images and the building proposal. The method then includes the verification module performing an overlay analysis to determine inconsistency between the building proposal and the plot data and the city master plan parameters retrieved from the GIS city map and the city map provisions. Thereafter, the method includes generating interactive scrutiny report, a comprehensive analysis report and a Management Information System (MIS) report by the report generating module followed by the billing module computing the fee associated with the plurality of activities including verification, site inspection visit followed by site inspection analysis, overlay analysis, compliance analysis, generation of reports, and issuance of certificates and NOC's. Thereafter, the billing module presents the invoice to the applicant to facilitate online payment of the computed fee. Thereafter, upon approval, the certificate issuing module issues digitally signed copies of the certificates and the NOC's to the applicant.

### BRIEF DESCRIPTION OF THE DRAWINGS

The objectives and advantages of the present invention will be more clearly understood from the following description of the invention taken in conjunction with the accompanying drawings, wherein;

FIG. 1 shows a system for automated approval of a building proposal, in accordance with the present invention;

FIGS. 2 and 3 is a flow-chart illustrating a method for automated approval of a building proposal, in accordance with the present invention;

FIGS. 4-6 illustrate different representations of the method for automated scrutiny and approval of a building proposal without human intervention, in accordance with the present invention; and

FIG. 7 shows overall system architecture, in accordance with the present invention.

### DETAILED DESCRIPTION OF THE INVENTION

The foregoing objects of the invention are accomplished, and the problems and shortcomings associated with the prior art techniques and approaches are overcome by the present invention as described below in the preferred embodiment.

The present invention provides a system and method for automated approval of a building proposal. The system and the method enable submission of a single building proposal through an automated single window platform and receiving therefrom a plurality of approvals and NOC's from building and construction authority and various government departments. The system and the method are thus cost-effective and reduces the time-cycle of approval of the building proposal.

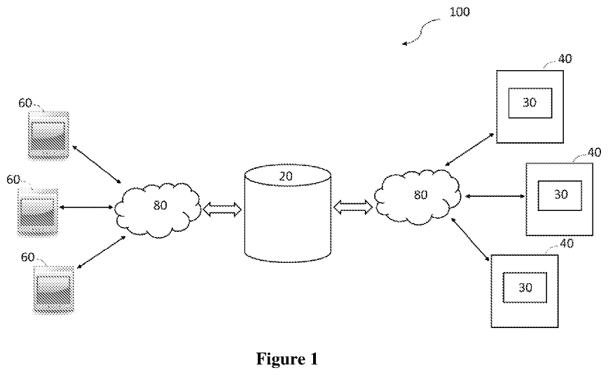

Referring to FIG. 1, in one aspect of the present invention, there is provided a system (100) (hereinafter referred to as “the system (100)) for automated approval of a plurality of building proposal (hereinafter referred to as “the building proposal”). The building proposal includes a building plan, Building Information Modeling (BIM) model, and documents related thereto along with applicant and owner related information. The building plan, for purpose of the present invention, includes AutoCAD (alternatively referred as “CAD”) drawings, and in one embodiment, is in .dwg format. The BIM model, for the purpose of the present invention, is necessarily a 3-dimensional (3D) BIM model, and in one embodiment, is in .rvt format. The BIM model, in another embodiment, is in .ifc (Industry Foundation Class) format. The building proposal is submitted by at least one applicant (hereinafter referred to as “the applicant”) for seeking approval from at least one building and construction authority (hereinafter referred to as “the building and construction authority”) for commencement of construction work. The applicant, for purpose of the present invention includes but is not limited to architects, structural engineers, builders, developers, firms and consultants for specific NOCs. The system (100) of the present invention enables registration of the applicants/personnel including but not limiting to architects, structural engineers, developers, builders, firms, consultants and the like. The building and construction authority, for the purpose of the present invention refers to jurisdiction specific local building and construction authority, and includes but is not limited to Pune Municipal Corporation, Bombay Municipal Corporation, Indore Municipal Corporation, Kochi Municipal Corporation, Hyderabad Metropolitan Development Authority, Haryana Urban Development Authority and Special Planning Authorities including but not limiting to Gujarat International Finance Tec-City (GIFT), Lavasa City, Maharashtra Industrial Development Corporation, Maharashtra Fire Services and the like.

In accordance with the present invention, the system (100) comprises of a central scrutiny server (20), a plurality of application server (40), and a plurality of computing device (60). The above-mentioned components are operatively connected with each other.

The central scrutiny server (20) is adapted for sending and receiving data over at least one communication network (80) (hereinafter referred to as “the communication network (80)”). The communication network (80) of the present disclosure includes but is not limited to, local area networks, wide area networks, aggregated networks such as the internet and cloud based computer network. The communication network (80) in one embodiment is wired. The communication network (80) in another embodiment is wireless. Typically, the communication network (80) allows the connected components to share content, information and enables interactive communication therebetween. The central scrutiny server (20) includes a Central Load-balancing and Distribution module configured thereon for uniform distribution/allocation of the building proposal received from the applicant over the communication network (80) for seeking approval from the building and construction authority for commencement of the construction work. Particularly, the Central Load-balancing and Distribution module is a web/window based service which keeps a track on number of the building proposals received from the applicant and number of the building proposals processed by the building and construction authority.

The plurality of application server (40), (hereinafter referred to as “the application server (40)”), is disposed in operable communication with the central scrutiny server (20) for sending and receiving data therefrom over the communication network (80). The application server (40) receives the building proposal uniformly allocated there amongst by the Central Load-balancing and

Distribution module. Further, each of the application server (40) includes a web application (30) configured thereon for automated approval of the building proposal received from the applicant. Particularly, multiple replicas of the web application (30) are running in infinite mode on the application server (40) waiting for the building proposal newly submitted by the applicant and distributed by the Central Load-balancing and Distribution module in accordance with a distribution algorithm implemented therein. In an embodiment, the building proposal submitted by the applicant is immediately taken up for further processing by the web application (30) sitting idle.

The web application (30) comprises of a rules database, a proposal database, a verification module, a mapping module, a report generating module, a billing module, a tracking module and a certificate issuing module. The afore-mentioned components/modules are operatively coupled with each other.

The rules database is provided for storing jurisdiction specific information pertaining to development control rules, byelaws, policies, sanctions and circulars issued by the building and construction authority. In one embodiment, the rules database maintains jurisdiction specific rules as centralized rules structure in terms of Structured Query Language (SQL) rule tables and master files. In another embodiment, the rules database maintains jurisdiction specific rules in terms of Extensible Markup Language, XML format.

The proposal database is provided for storing the building proposal for future use and reference. In an embodiment, the proposal database stores the building proposal received from the applicant seeking approval/permit letter for commencement of the construction work, the building proposal approved by the building and construction authority and the building proposal rejected by the building and construction authority. The proposal database also includes the building proposal received from the applicant seeking approval/permit letter for any one stage selected from plinth stage, completion stage and occupancy stage. The building proposal submitted by the applicant are queued within the proposal database awaiting further processing.

The verification module is provided for verifying correctness and authenticity of the building proposal in addition to performing a site inspection analysis and an overlay analysis prior to approval of the building proposal by the building and construction authority. The site inspection analysis is performed after at least one site inspection visit, (hereinafter referred to as “the site inspection visit”), by the at least one government officer, (hereinafter referred to as “the government officer”). In an embodiment, the government officer includes a building inspector. The site inspection visit enables securing entry of readings, observations, documents, evidence, capturing on-site electronic images, videos and the like, by the government officer. After the site inspection visit, a site inspection visit report is prepared by the government officer based on the afore-mentioned entries. The site inspection analysis uses the site inspection visit report and the on-site images captured and uploaded onto the web application (30) via the central scrutiny server (20) using at least one handheld device, (hereinafter referred to as “the handheld device”) by the government officer. For purpose of the present invention, the handheld device refers to the handheld computing device and includes but not limited to a PDA, cellphone, portable laptop computer, iPad and combinations thereof. In an embodiment, the government officer also uploads a site inspection video. The verification module while performing the site inspection analysis compares the building proposal submitted by the applicant with the site inspection visit report and the on-site images uploaded by the government officer. The verification module following the site inspection analysis, reports an element of the building proposal inconsistent with the site inspection visit report and the on-site images, provides a reason for occurrence of such inconsistency, and proposes a strategy for removal/clearance of said inconsistency. The overlay analysis uses plot data and city master plan parameters retrieved automatically from a GIS city map stored in a GIS database which is stored in the rules database. Particularly, the GIS database contains a city specific master plans and zonal plans. The verification module while performs the overlay analysis along with geometrical mapping by overlaying the building plan and the BIM model onto the plot data and the city master plan parameters/city map provisions to report an element of the building proposal inconsistent therewith, and provides a reason of occurrence of such inconsistency. The verification module further provides recommendations by proposing a strategy for clearance of said inconsistency.

The mapping module is provided to perform compliance analysis (rule mapping) by mapping the building proposal against the rules database to check compliance therewith. Particularly, the mapping module maps the building plan and the BIM model against the rules database to check compliance therewith. More particularly, the mapping module maps the rules database with geometrical objects present within the BIM model and the building plan/drawing to screen compliance thereof with the rules database. Following the compliance analysis, the mapping module reports a non-compliant element of the building proposal along with reasons of occurrence of such non-compliance, and further provides recommendations for clearance of said non-compliance to bring out the non-compliant element into compliance. More particularly, the mapping module further to compliance analysis provides a compliance status selected from any one of compliance passed and compliance failed, for each rule present within the rules database. The non-compliant element/deviations in the building proposal with respect to the rules database are reported by highlighting said deviations within the BIM model and the building plan/drawing using any one technique selected from, but not limiting to, auto-hatching and auto-zooming. In an embodiment, the area statements and dimensions are automatically generated in the building plan/CAD drawing and the BIM model.

The report generating module is provided for generating at least one report, (hereinafter referred to as “the report”), selected from the group consisting of a plurality of reports including but not limiting to, an interactive scrutiny report, a comprehensive analysis report, a Management Information System (MIS) report and like. In an embodiment, the report generating module also generates the drawings in .pdf format for viewing by the applicant. The report generating module generates the report based upon findings of the verification module and the mapping module. The report generating module also generates an error report including a set of outstanding errors within the building plan along with reporting errors within the BIM model. In an embodiment, the report is generated in printed format. In another embodiment, the report is generated online and the applicant, the building and construction authority and at least one government department is provided a web access for viewing the report, graph, chart, real-time information and like through one common automated user interface. The at least one government department, (hereinafter referred to as “the government department”), for purpose of the present invention, refers to local concerned government departments and includes but is not limited to, building permission department, fire department, garden department, land acquisition department, tax department, water department, drainage department and the like. In yet another embodiment, an online status update is displayed on an interactive dashboard pursuant to findings of the verification module and the mapping module. The report generated by the report generating module is archived against the respective building proposal within the proposal database for future use and referencing.

The billing module is provided for automatically computing a fee associated with at least one activity selected from the group consisting of a plurality of activities including, but not limiting to, verification of the building proposal, site inspection visit and the site inspection analysis of the building proposal, the overlay analysis of the building plan and the BIM model, the compliance analysis of the building proposal against the rules database, generation of the plurality of reports, and furnishing a digitally signed copy of at least one certificate, (hereinafter referred to as “the certificate”), obtained from the building and construction authority and at least one No-Objection Certificate (NOC), (hereinafter referred to as “the NOC”), obtained from the government department further to approval of the building proposal. The billing module, in one embodiment, presents at least one invoice to the applicant along with at least one payment module to facilitate online payment of the computed fee by the applicant. The billing module, in another embodiment, presents any one of a challan and a demand note along with said payment module to facilitate online payment of the computed fee by the applicant.

The tracking module is provided for scheduling date and time of the site inspection visit of the government officer, and thereafter communicating details of the site inspection visit including the scheduled date and time to the applicant and the government officer. The tracking module is adapted to send alerts to confirm the site inspection visit of the government officer on the scheduled date and time. In an embodiment, geo-coordinated site photographs/images and site locations are captured on google maps to confirm the site inspection visit of the government officer. In addition, the tracking module enables display of the process flow and approval status of the building proposal and enables providing an intimation to the applicant about the progress of the building proposal at different stages. The tracking module provides status update by generating alerts and notifications for the applicant at pre-determined time intervals informing about progression of the building proposal submitted by the applicant for seeking approval from the building and construction authority. The status update, for purpose of the present invention, is provided in at least one format selected from the group including but not limiting to, a short messaging service (SMS) message, a multimedia messaging service (MMS) message, a voice call, an email message and combinations thereof. The tracking module further enables displaying the building proposal either approved or rejected by the building and construction authority. In another embodiment, the applicant accesses the web application (30) via the central scrutiny server (20) over the communication network (80) to track progression of the building proposal online.

The certificate issuing module is provided for issuing digitally signed copy of the certificate and the NOC upon successful approval of the building proposal submitted by the applicant. The digitally signed copy of the certificate includes, but not limited to, commencement certificate, completion certificate and an occupancy certificate, and is obtained from the building and construction authority. The certificate issuing module processes issuance of the digitally signed copy of the commencement certificate upon approval of the building proposal but before commencement of the construction work. The commencement certificate is issued only upon receipt of the NOCs from the government department. In an embodiment, the certificate issuing module also generates a plinth check certificate issued after commencement but before completion of the construction work. Particularly, post issuance of the commencement certificate, upon completion of the plinth stage, again compliance checking is initiated to check if the construction is in accordance with the approved building proposal. Thereafter, the plinth check certificate is issued by the certificate issuing module. Further, the certificate issuing module processes issuance of the digitally signed copy of the completion certificate upon completion of the construction work in accordance with the building proposal approved by the building and construction authority. The certificate issuing module processes issuance of the digitally signed copy of the occupancy certificate prior to occupation of the building or part thereof begins and upon compliance of the building or part thereof with the building proposal approved by the building and construction authority. The digitally signed copy of the NOC relevant to each of the building proposal submitted by the applicant is identified by the certificate issuing module along with the applicant and is obtained from the government department post approval. In an embodiment, parallel processing of the NOCs by the government department takes place. The NOCs for purpose of the present invention, are selected from the group consisting of, but not limited thereto, pre-commencement No-Objection Certificates (NOCs) and post completion NOCs, and further includes but not limited to, Fire NOC, Garden NOC, Tax NOC, Water NOC, Tree NOC, Tree cutting NOC, Airports Authority NOC, Environmental Department NOC, Defense Department NOC, Railway NOC, National Monuments Authority NOC, Water meter NOC, Drainage NOC, LBT NOC, Encroachment NOC, Rain water harvesting, Vermi compost NOC, Solar water heating NOC and like. Further, the digitally signed copy of the certificate and the NOC are archived in the proposal database for future use and referencing.

The plurality of computing device (60), (hereinafter referred to as “the computing device (60)”), is disposed in operable communication with the central scrutiny server (20) to facilitate data transfer therebetween over the communication network (80). For purpose of the present invention, data includes but is not limited to forms, certificates, NOCs, drawings, models, 3D BIM models, building plans, applicant and owner related information and other documents related to the building proposal. Each of the computing device (60) includes at least one processor for processing data stored within at least one memory coupled thereto, at least one input device coupled to the at least one processor for inputting data, and at least one display device coupled to the at least one processor and the at least one memory for displaying information processed by the at least one processor. Additionally, each of the computing device (60) is further configured with a CAD/CAM system and an error reporting module coupled thereto. The CAD/CAM system facilitates designing of the building plan and the BIM model by the applicant, whereas the error reporting module reports drafting and modeling errors and the reasons behind these errors in the building plan and the BIM model designed using the CAD/CAM system. Furthermore, the error reporting module also suggest ways in which the applicant can avoid making the afore-stated errors. The building proposal including the building plan and the BIM model along with the documents related thereto, and the applicant and owner related information is uploaded on the web application (30) using the computing device (60). Particularly, the computing device (60) is used by the applicant for uploading and submitting the building proposal onto the web application (30) via the central scrutiny server (20) for seeking approval and for receiving therefrom over the communication network (80) the digitally signed copy of the certificate and the NOC generated by the certificate issuing module post approval on the building proposal from the building and construction authority.

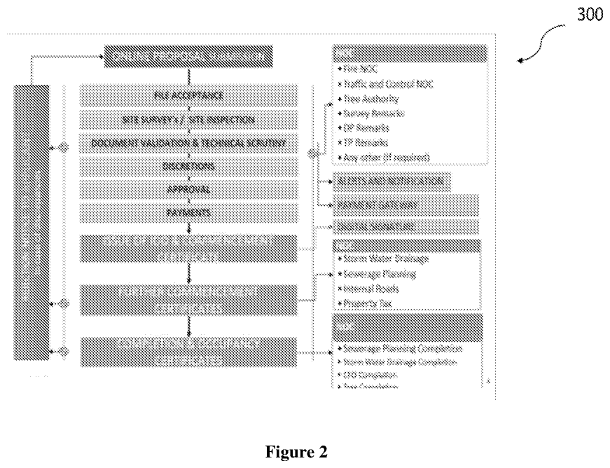

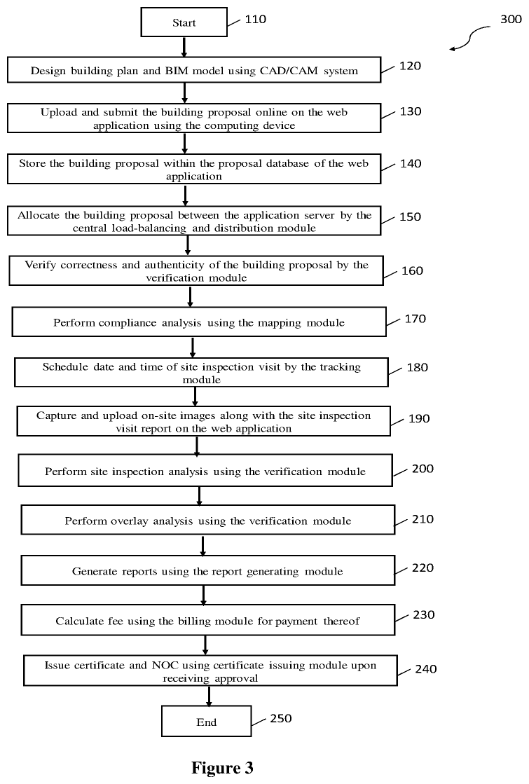

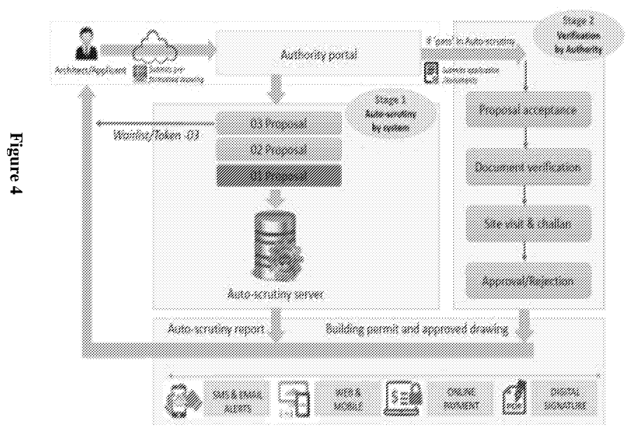

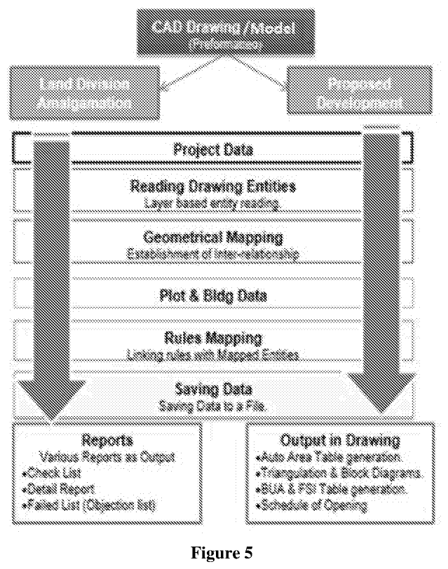

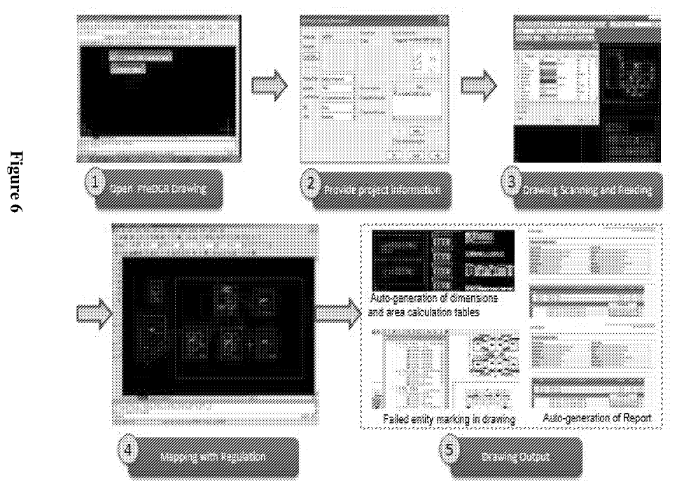

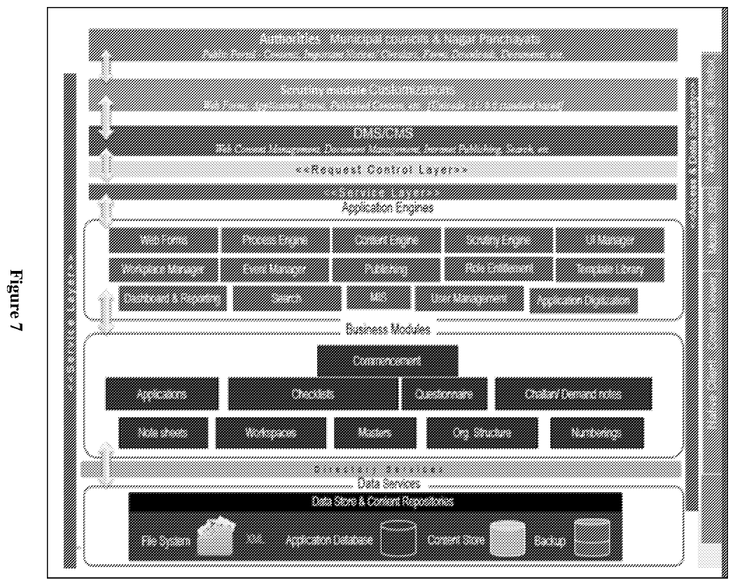

Referring to FIGS. 2 and 3, in accordance with another aspect, the present invention provides a method (300), (hereinafter referred to as “the method (300)”) for automated approval of the building proposal. FIGS. 4-6 illustrates different representations of the method (300) for automated scrutiny and approval of a building proposal without human intervention. The method (300) is described in detail hereinbelow in conjunction with the FIG. 3 and using the afore-mentioned components of the system (100). In an embodiment, the method (300) operates over the communication network (80). The method starts at step (110).

At step (120), the method (300) includes designing of the building plan and the BIM model by the applicant using the CAD/CAM system configured on the computing device (60). The error reporting module coupled to the CAD/CAM system facilitates reporting of the drafting and the modeling errors detected within the building plan and the BIM model designed using the CAD/CAM system.

At step (130), the method (300) includes uploading and submission of the building proposal onto the web application (30) by the applicant using the computing device (60). The web application (30) is configured on the application server (40). The applicant uploads the building proposal for submission thereof onto the web application (30) which is accessible through the central scrutiny server (20) coupled to the application server (40). The BIM model is uploaded in any one format selected from .rvt and .ifc formats. In an embodiment, if the BIM model is uploaded in any other format, the web application (30) converts the BIM model into .ifc format before further processing. Further to uploading of the BIM model, the web application (30) automatically generates area and dimension calculations.

At step (140), the method (300) includes storing of the building proposal within the proposal database of the web application (30). In an embodiment, the proposal database is adapted to store the building proposal received from the applicant for seeking approval and the building proposal rejected or approved by the building and construction authority.

At step (150), the method (300) includes allocation of the building proposal by the Central Load-balancing and Distribution module configured on the central scrutiny server (20). The building proposal stored within the proposal database for seeking approval from the building and construction authority are uniformly distributed between the application server (40) for further processing by the web application (30) configured thereon.

At step (160), the method (300) includes verification of the building proposal for ensuring correctness and checking authenticity thereof by the verification module of the web application (30).

At step (170), the method (300) includes performing compliance analysis by mapping the building proposal against a rules database to check compliance therewith using the mapping module of the web application (30). Further to the compliance analysis, the mapping module reports the non-compliant element of the building proposal along with providing reasons behind such non-compliance, and proposes a strategy for addressing said non-compliance.

At step (180), the method (300) includes scheduling the date and time for the site inspection visit of the government officer by the tracking module of the web application (30). The tracking module further communicates the scheduled date and time to the government officer and the applicant, and thereafter tracks and sends alerts regarding location of the government officer to confirm the site inspection visit. In an embodiment, geo-coordinated site photographs/images and site locations are captured on google maps to confirm the site inspection visit of the government officer.

At step (190), the method (300) includes capturing on-site images using the handheld device and preparing the site inspection visit report after the site inspection visit by the government officer. Thereafter, the method (300) includes the government officer uploading the on-site images along with the site inspection visit report onto the web application (30) over the communication network (80) using the handheld device.

At step (200), the method (300) includes performing the site inspection analysis by comparing the building proposal with the on-site images and the site inspection visit report using the verification module of the web application (30). Further to the site inspection analysis, the verification module reports the element of the building proposal inconsistent with the on-site images and the site inspection visit report along with providing reasons of such inconsistency, and proposing a strategy for addressing said inconsistency.

At step (210), the method (300) includes performing the overlay analysis by overlaying the building plan and the BIM model onto the plot data and the city master plan parameters retrieved from the GIS city map and the city map provisions stored within the rules database. Particularly, the method (300) includes automatically reading plot and the city master plan parameters from GIS map, auto-fill application form and survey remarks, checking of drawing objects (the BIM model) against the city map provisions with the help of overlay analysis and updating the building proposal approval status on the GIS city maps. More specifically, the method (300) includes capturing plot data from approved city map in the building proposal/application form. The method (300) and the system (100) of the present invention capture the city master plan parameters from approved city map and extract part plan of the plot. Further to the overlay analysis, the verification module reports the element of the building plan and the BIM model inconsistent with the plot data and the city master plan parameters along with providing reasons of such inconsistency, and proposing a strategy for addressing said inconsistency.

Further to the compliance analysis, site inspection analysis and the overlay analysis, if the building proposal is found to be inconsistent, then the building proposal is rejected by the building and construction authority and the applicant is alerted accordingly to amend the building proposal and re-submit for seeking approval from the building and construction authority. In this event, the applicant is asked to make a payment for the fee computed by the billing module in respect of the compliance analysis, site inspection analysis and the overlay analysis.

At step (220), the method (300) includes generating plurality of reports including an interactive scrutiny report, a comprehensive analysis report and a Management Information System (MIS) report based upon findings of the verification module and the mapping module using the report generating module of the web application (30). The generated reports are displayed on an interactive dashboard for viewing by the applicant and the building and construction authority along with the government department.

At step (230), the method (300) includes the billing module computing a fee associated with the plurality of activities including the verification, site inspection visit, generation of the site inspection visit report, the site inspection analysis, overlay analysis and compliance analysis of the building proposal, and generation of plurality of reports. In addition, the billing module computes a fee associated with issuance of the certificate and the NOC, in the event the building proposal gets approved from the building and construction authority. Thereafter, the method (300) further includes the billing module presenting the invoice to the applicant along with the payment module to facilitate online payment of the total fee computed by the billing module.

At step (240), the method (300) includes issuing digitally signed copy of the certificate and the NOC by the certificate issuing module of the web application (30) upon receiving approval on the building proposal submitted by the applicant. The certificate includes the commencement certificate issued upon approval of the building proposal, the completion certificate issued upon completion of the construction work and approval thereof and the occupancy certificate issued prior to occupancy of the building upon compliance thereof with the approved building proposal. The method (300) ends at step (250).

In other embodiment, the method (300) operates in offline mode, wherein only the compliance analysis of the building proposal takes place on the computing device (60) used by the applicant which is installed with the web application (30) for facilitating automated approval of the building proposal. In offline mode, the web application (30) configured on the computing device (60) requests a web service for appropriate rule table and master file from the rules database of the web application (30) configured either on the application server (40) or on the central scrutiny server (20). Accordingly, the web service using a download agent downloads the rule file and the master file. In an embodiment, if the rule file is in terms of the SQL rule tables, then the web service after downloading converts the SQL rule tables into an XML rule file using a SQL-XML rule converter coupled thereto. Thereafter, the web service feeds the appropriate rule file and the master file in XML format to the web application (30) configured on the computing device (60) of the applicant. Thereafter, the verification module of the web application (30) ensures correctness and checks authenticity of the building proposal present within the computing device (60) of the applicant. The mapping module then performs the compliance analysis by mapping the building proposal against the rules file and the master file to check compliance therewith and generates a report for reporting the non-compliant element along with reasons of such non-compliance and the strategy for addressing the same. The report generated is then uploaded online against said building proposal onto the web application (30) configured on the application server (40). The report is uploaded over the communication network (80) using the computing device (60) against said building proposal for further processing thereof. The rules file and master files downloaded by the web service are deleted immediately from the computing device (60) after fetching of the rules for security purposes.

During processing of the building proposal, the system (100) and the method (300) enables providing status update to the applicant at pre-determined time intervals using the tracking module of the web application (30). The status update is provided in at least one format selected from the group including but not limiting to, a short messaging service (SMS) message, a multimedia messaging service (MMS) message, a voice call, an email message and combinations thereof. The status updates inform the applicant about progress of the building proposal submitted for receiving approval from the building and construction authority. Alternatively, progression of the building proposal is tracked by the applicant by accessing the web application (30) through the central scrutiny server (20) over the communication network (80). Further, the certificates and the NOC's are available for viewing by common public/citizens via a citizen interface after approval of the building proposal, in addition to availability of the building proposal approved or rejected, thereby bringing transparency in the system (100) and the method (300) of approving the building proposal.

Thus, the system (100) and the method (300) enables the building and construction authority to scrutinize the submitted building proposal with associated data through automation without any manual intervention for approving or rejecting the building proposal submitted by the applicant. The system (100) is integrated with plurality of city, state and national level government departments and building and construction authority to check compliance therewith along with other departments, including but not limiting to water, electricity, drainage, road, park, airport, monuments and like. The system (100) and the method (300) of the present invention enables the data and the certificate to be signed digitally. The system (100) and the method (300) of the present invention identifies the NOCs required for each application containing the building proposal based on type of the building proposal submitted for seeking approval and facilitates submission of requisite data to all the requisite building and construction authority and the government departments by making one application. The system (100) and the method (300) of the present invention generates the requisite NOCs after approval. The system (100) of the present invention is integrated with the geographic information system (GIS) and Enterprise Resource Planning (ERP) systems. The system (100) and the method (300) of the present invention enables sharing of the data and the reports between various government authorities and departments through one common automated interface. The system (100) and the method (300) enables the citizens to view online and check details of the building proposals including the certificate and the NOC's issued after approval by the building and construction authority. Further the citizens are enabled to track online the status of the building proposal submitted by the applicant. In addition, the system (100) and the method (300) enables calculation of all areas and the fees automatically by reading objects present in the CAD drawings and the BIM model. The system (100) and the method (300) scrutinizes the building proposals in queue (First-In First-Out (FIFO)) automatically and provides scrutiny results online to the applicant without any manual intervention. The system (100) and the method (300) additionally permits the government officer to modify the building codes/regulations present within the rules database that gets automatically updated during scrutiny of the CAD drawings and the BIM model.

The embodiments described herein above are non-limiting. The foregoing descriptive matter is to be interpreted merely as an illustration of the concept of the present invention and it is in no way to be construed as a limitation. Description of terminologies, concepts and processes known to persons acquainted with technology has been avoided to preclude beclouding of the afore-stated embodiments.

### TECHNICAL ADVANTAGES AND ECONOMIC SIGNIFICANCE

The technical advantages and economic significance of the method and system of the present invention include but are not limited to:
1. Reduction in the time-cycle of approval
2. Saving in costs incurred in the building proposal scrutiny and approval
3. Auto-generation of regular MIS report
4. Auto-generation of compliance check report
5. Approval status on city maps for home buyers/citizens
6. Auto-generation of NOCs
7. Storage and archival of all digitized data records.
8. Escalation of alerts to avoid unnecessary delays
9. Precludes instances of human error.

The foregoing objects of the invention are accomplished, and the problems and shortcomings associated with prior art techniques and approaches are overcome by the present invention described in the present embodiment. Detailed descriptions of the preferred embodiment are provided herein; however, it is to be understood that the present invention may be embodied in various forms.

Therefore, specific details disclosed herein are not to be interpreted as limiting, but rather as a basis for the claims and as a representative basis for teaching one skilled in the art to employ the present invention in virtually any appropriately detailed system, structure, or matter. The embodiments of the invention as described above, and the methods disclosed herein will suggest further modification and alterations to those skilled in the art. Such further modifications and alterations may be made without departing from the scope of the invention.

We claim:

1. A system (100) for automated approval of a building proposal, the building proposal including a building plan, a Building Information Modeling (BIM) model, and documents related thereto along with applicant and owner related information, the system (100) comprising:
a central scrutiny server (20) capable of sending and receiving data over at least one communication network, the central scrutiny server (20) having a Central Load-balancing and Distribution module configured thereon for uniform distribution of the building proposal submitted by at least one applicant to seek approval from at least one building and construction authority for commencement of construction work;
a plurality of application server (40) operably coupled to the central scrutiny server (20) for sending and receiving data therefrom over the at least one communication network, wherein, the plurality of application server receives the building proposal uniformly allocated thereto by the Central Load-balancing and Distribution module, and wherein each application server (40) of the plurality of application server (40) being configured with a web application (30) for facilitating automated approval of the building proposal, the web application (30) comprising,
a rules database having jurisdiction specific information stored therein pertaining to development control rules, byelaws, policies, sanctions and circulars issued by the at least one building and construction authority,
a proposal database having the building proposal stored therein including the building proposal received from the at least one applicant seeking approval for commencement of the construction work, the building proposal approved by the at least one building and construction authority, and the building proposal rejected by the at least one building and construction authority,
a verification module configured for verifying the correctness and authenticity of the building proposal prior to approval thereof by the at least one building and construction authority, the verification module adapted to perform,
i. site inspection analysis by comparing the building proposal with site inspection visit report and on-site images for reporting an element of the building proposal inconsistent therewith along with reasons thereof and proposing a strategy for clearance of said inconsistency, wherein the site inspection visit report and the on-site images being captured and uploaded on the web application (30) through the central scrutiny server (20) by at least one government officer using at least one handheld device following a site inspection visit, and
ii. overlay analysis by overlaying the building plan and the BIM model onto plot data and city master plan parameters for reporting an element of the building plan and the BIM model inconsistent therewith along with reasons thereof and proposing a strategy for clearance of said inconsistency, wherein the plot data and the city master plan parameters being automatically retrieved from a GIS city map stored within the rules database,
a mapping module configured for performing compliance analysis by mapping the building proposal against the rules database to check compliance therewith for reporting a non-compliant element of the building proposal along with reasons thereof and proposing a strategy for clearance of said non-compliance,
a report generating module configured for generating at least one report selected from the group consisting of an interactive scrutiny report, a comprehensive analysis report and a Management Information System (MIS) report based upon findings of the verification module and the mapping module, and thereafter displaying a status update on an interactive dashboard,
a billing module configured for computing a fee associated with at least one activity selected from the group consisting of verification of the building proposal, site inspection visit and the site inspection analysis of the building proposal, overlay analysis of the building plan and the BIM model, compliance analysis of the building proposal against the rules database, generation of the interactive scrutiny report, the comprehensive analysis report and the MIS report, and issuance of digitally signed copy of at least one certificate along with at least one No-objection certificate (NOC); and thereafter presenting at least one invoice to the at least one applicant along with at least one payment module to facilitate online payment of the fee computed by the billing module,
a tracking module configured for scheduling date and time of at least one site inspection visit of the at least one government officer, communicating the site inspection visit details including the scheduled date and time to the at least one applicant and the at least one government officer, and thereafter sending alerts to confirm the site inspection visit of the at least one government officer on the scheduled date and time, the tracking module being further adapted for providing the status update to the at least one applicant at a pre-determined time interval informing about progression of the building proposal submitted by the at least one applicant, wherein the at least one applicant being additionally capable of accessing the web application (30) through the central scrutiny server (20) over the at least one communication network for tracking the progression of the building proposal, and
a certificate issuing module configured for issuing the digitally signed copy of the at least one certificate and the at least one NOC, wherein the at least one certificate being obtained from the at least one building and construction authority whereas the at least one NOC being identified by the certificate issuing module along with the at least one applicant and obtained from at least one government department, and wherein the at least one certificate being selected from the group consisting of a commencement certificate issued upon approval of the building proposal, a completion certificate issued upon completion of the construction work and approval thereof and an occupancy certificate issued prior to occupancy of the building upon compliance thereof with the building proposal approved by the building and construction authority; and
a plurality of computing device (60) operably coupled to the central scrutiny server (20) for data transfer therebetween over the at least one communication network, each computing device of the plurality of computing device being configured with a CAD/CAM system and an error reporting module operatively coupled thereto, wherein the CAD/CAM system enables designing of the building plan and the BIM model whereas the error reporting module facilitates reporting drafting and modeling errors identified within the building plan and the BIM model designed using the CAD/CAM system, and wherein the plurality of computing device (60) being used by the at least one applicant for uploading and submitting the building proposal for approval thereof onto the web application (30) via the central scrutiny server (20) and for receiving therefrom over the at least one communication network the digitally signed copy of the at least one certificate and the at least one NOC generated by the certificate issuing module upon receiving approval from the building and construction authority,
wherein, each computing device of the plurality of computing device (60) further includes at least one processor for processing data stored within at least one memory coupled thereto, at least one input device coupled to the at least one processor for inputting data, and at least one display device coupled to the at least one processor and the at least one memory for displaying information processed by the at least one processor, and
wherein, the proposal database archives the interactive scrutiny report, the comprehensive analysis report and the MIS report for each of the building proposal received from the at least one applicant, along with maintaining the digitally signed copy of the at least one certificate and the at least one NOC issued by the certificate issuing module for each of the building proposal approved by the at least one building and construction authority.

2. The system (100) as claimed in claim 1, wherein the building plan is uploaded in .dwg format, whereas the BIM model is uploaded in at least one format selected from the group consisting of .rvt, and .ifc format.

3. The system (100) as claimed in claim 1, wherein the status update is provided in at least one format selected from the group consisting of a short messaging service (SMS) message, a multimedia messaging service (MMS) message, a voice call, an email message and combinations thereof.

4. A method (300) for automated approval of a building proposal, the building proposal including a building plan, a Building Information Modeling (BIM) model, and documents related thereto along with applicant and owner related information, the method (300) comprising the steps of:
designing of the building plan and the BIM model by at least one applicant using a CAD/CAM system configured on a plurality of computing device (60), the CAD/CAM system having an error reporting module operatively coupled thereto for reporting drafting and modeling errors within the building plan and the BIM model designed using the CAD/CAM system, wherein each computing device of the plurality of computing device (60) includes at least one processor for processing data stored within at least one memory coupled thereto, at least one input device coupled to the at least one processor for inputting data, and at least one display device coupled to the at least one processor and the at least one memory for displaying information processed by the at least one processor;
uploading and submission of the building proposal onto a web application (30) via a central scrutiny server (20) using the plurality of computing device (60) coupled thereto by the at least one applicant over at least one communication network for seeking approval on the building proposal from at least one building and construction authority prior to commencement of construction work, the web application (30) for facilitating automated approval of the building proposal being configured on each of a plurality of application server (40) operably coupled to the central scrutiny server (20) for sending and receiving data therefrom over the at least one communication network;
storing of the building proposal within a proposal database of the web application (30), wherein the proposal database being adapted to store the building proposal received from the at least one applicant for seeking approval for commencement of the construction work, the building proposal approved by the at least one building and construction authority and the building proposal rejected by the at least one building and construction authority;
allocation of the building proposal among the plurality of application server (40) by a Central Load-balancing and Distribution module configured on the central scrutiny server (20) for uniform distribution of the building proposal received from the at least one applicant for seeking approval for commencement of the construction work;
verification of the building proposal for ensuring correctness and authenticity thereof by a verification module of the web application (30);
performing compliance analysis by mapping the building proposal against a rules database to check compliance therewith for reporting a non-compliant element of the building proposal along with reasons thereof and proposing a strategy for clearance of said non-compliance using a mapping module of the web application (30), wherein, the rules database includes jurisdiction specific information stored therein pertaining to development control rules, byelaws, policies, sanctions and circulars issued by the at least one building and construction authority;
scheduling a date and time of at least one site inspection visit of at least one government officer, communicating the site inspection visit details including the scheduled date and time to the at least one applicant and the at least one government officer, and thereafter sends alerts to confirm the site inspection visit of the at least one government officer on the scheduled date and time by a tracking module of the web application (30);
capturing on-site images by the at least one government officer using at least one handheld device and thereafter uploading the on-site images along with a site inspection visit report by the at least one government officer on the web application (30) over the at least one communication network;
performing a site inspection analysis by comparing the building proposal with the on-site images and the site inspection visit report for reporting an element of the building proposal inconsistent therewith along with reasons thereof and proposing a strategy for clearance of said inconsistency by the verification module of the web application (30);
performing an overlay analysis by overlaying the building plan and the BIM model onto plot data and city master plan parameters for reporting an element of the building plan and the BIM model inconsistent therewith along with reasons thereof and proposing a strategy for clearance of said inconsistency by the verification module of the web application (30), wherein the plot data and the city master plan parameters being automatically retrieved from a GIS city map stored within the rules database;
generating at least one report selected from the group consisting of an interactive scrutiny report, a comprehensive analysis report and a Management Information System (MIS) report based upon findings of the verification module and the mapping module by a report generating module of the web application (30) and thereafter displaying a status update on an interactive dashboard;
computing a fee associated with at least one activity selected from the group consisting of verification of the building proposal, site inspection visit followed by site inspection analysis of the building proposal, overlay analysis of the building plan and the BIM model, compliance analysis of the building proposal against the rules database, generation of the interactive scrutiny report, the comprehensive analysis report and the MIS report, and issuance of at least one certificate along with at least one No-objection certificate (NOC) by a billing module of the web application (30), and thereafter presenting at least one invoice to the at least one applicant along with at least one payment module to facilitate online payment of the fee computed by the billing module; and
issuing to the applicant a digitally signed copy of the at least one certificate and the at least one NOC by a certificate issuing module of the web application (30), wherein the at least one certificate being issued by the at least one building and construction authority whereas the at least one NOC being identified by the certificate issuing module along with the at least one applicant and issued by at least one government department, and wherein, the at least one certificate being selected from the group consisting of a commencement certificate issued upon approval of the building proposal, a completion certificate issued upon completion of the construction work and approval thereof and an occupancy certificate issued prior to occupancy of the building upon compliance thereof with the approved building proposal,
wherein, the at least one applicant receives the status update from the tracking module at a pre-determined time interval informing about progression of the building proposal,
and wherein, the proposal database archives the interactive scrutiny report, the comprehensive analysis report and the MIS report for each of the building proposal received from the at least one applicant, along with maintaining the digitally signed copy of the at least one certificate and the at least one NOC issued by the certificate issuing module for each of the building proposal approved by the at least one building and construction authority.

5. The method (300) as claimed in claim 4, wherein uploading and submission of the building plan is in .dwg format, whereas uploading and submission of the BIM model is in at least one format selected from the group consisting of .rvt, and .ifc format.

6. The method (300) as claimed in claim 4, wherein reception of the status update by the at least one applicant is in at least one format selected from the group consisting of a short messaging service (SMS) message, a multimedia messaging service (MMS) message, a voice call, an email message and combinations thereof.

7. The method (300) as claimed in claim 4, wherein the progression of the building proposal is tracked by the at least one applicant by accessing the web application (30) through the central scrutiny server (20) over the at least one communication network.

8. The method (300) as claimed in claim 4, being carried out in at least one mode selected from the group consisting of an online mode and an offline mode.
